(19) United States
(12) Patent Application Publication
(10) Pub. No.: US 2025/0080687 A1
(43) Pub. Date: Mar. 6, 2025

(54) SURROUND VIEW USING REAR VIEW CAMERA

(71) Applicant: TEXAS INSTRUMENTS INCORPORATED, Dallas, TX (US)

(72) Inventors: Christopher BROADHURST, Carp (CA); Lucas WEAVER, Dallas, TX (US)

(21) Appl. No.: 18/240,781

(22) Filed: Aug. 31, 2023

(51) Int. Cl. H04N 5/262; H04N 7/18; H04N 23/80

(52) U.S. Cl. CPC H04N 5/2624; H04N 7/183; H04N 23/80; B60R 1/27; B60R 2300/105; B60R 2300/303

(57) ABSTRACT

A circuit includes a first processor core, a second processor core, and a video processing circuit. The first processor core is configured to program the video processing circuit to: provide a rear view image processing path, and to transfer a rear view image from the rear view image processing path to a surround view image processing path. The second processor core is configured to program the video processing circuit to provide the surround view image processing path, to receive the rear view image from the rear view image processing path, and to provide a surround view image based on the rear view image.

### BACKGROUND

Advanced driver assistance systems (ADAS) provide functionality such as rear-view cameras, electronic stability control, and vision-based pedestrian detection systems. Many of these systems rely on computer vision processing to detect objects in the field of view of one or more cameras. The surround view camera system is an ADAS technology that allows the driver to see a top-down view of the 360 degree surroundings of the vehicle. Such a system normally includes four to six wide-angle cameras mounted around the vehicle, each facing a different direction. From these camera inputs, a composite view of the surroundings of the vehicle is synthesized and displayed in real-time.

### SUMMARY

In one example, a circuit includes a first processor core, a second processor core, and a video processing circuit. The first processor core is configured to program the video processing circuit to: provide a rear view image processing path, and to transfer a rear view image from the rear view image processing path to a surround view image processing path. The second processor core is configured to program the video processing circuit to provide the surround view image processing path, to receive the rear view image from the rear view image processing path, and to provide a surround view image based on the rear view image.

In another example, a method includes programming a video processing circuit to provide a rear view image processing path, and generating a rear view image in the rear view image processing path. The method also includes programming the video processing circuit to provide a surround view image processing path, and transferring the rear view image from the rear view image processing path to the surround view image processing path. The method further includes generating a surround view image, based on the rear view image, in the surround view image processing path.

In a further example, a system includes a camera interface, a video processing circuit, a first processor core, a second processor core, and a display interface. The camera interface is configured to receive a rear view video signal, a first side view video signal, a second side view video signal, and a front view video signal. The video processing circuit is coupled to the camera interface. The first processor core is coupled to the video processing circuit. The first processor core is configured to program the video processing circuit to provide a rear view image processing path, to provide a rear view image based on the rear view video signal, and to transfer the rear view image from the rear view image processing path to a surround view image processing path. The second processor core is coupled to the video processing circuit, the second processor core is configured to program the video processing circuit to provide the surround view image processing path, receive the rear view image from the rear view image processing path, and provide a surround view image based on the rear view image. The display interface is coupled to the video processing circuit, the display interface is configured to provide the rear view image and the surround view image to a video display device.

### BRIEF DESCRIPTION OF THE DRAWINGS

FIG. 1 is an example of video signal flow in a system that uses rear view camera images in a surround view.

FIG. 2 is a block diagram of example processing of rear view camera images prior to initialization of surround view processing.

FIG. 3 is a block diagram of example processing of video from multiple cameras for generating a surround view using the rear view image processing of FIG. 2.

FIG. 4 is a block diagram of an example processing circuit suitable for implementing the rear view processing and surround view processing of FIGS. 2 and 3.

FIG. 5 is a flow diagram for an example method of providing a surround view image based on images provided by a rear view image processing path.

### DETAILED DESCRIPTION

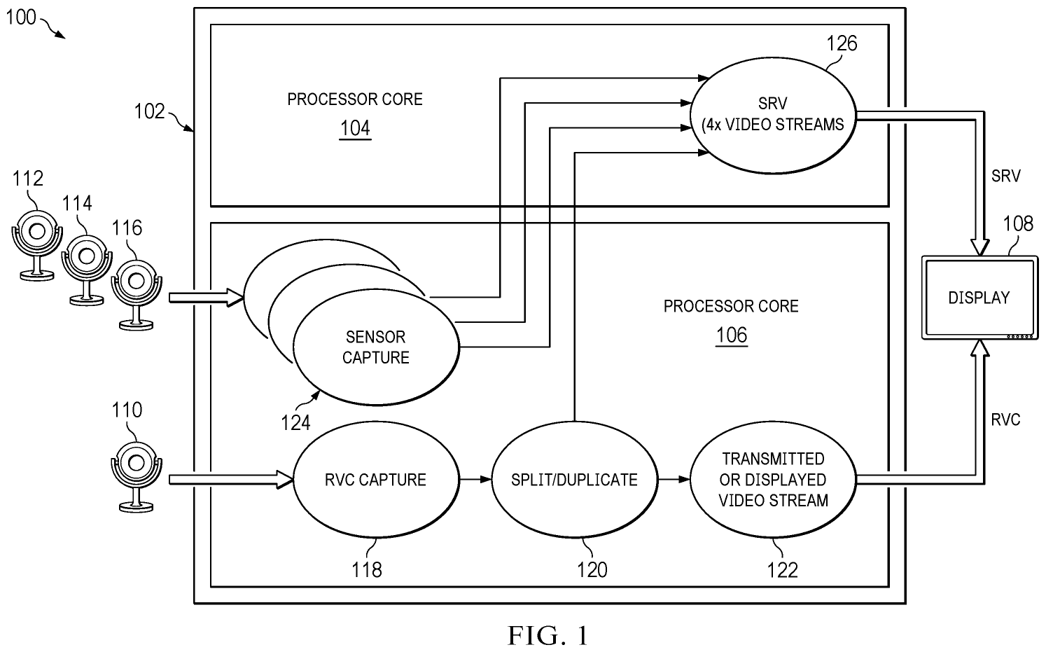

FIG. 1 is an example of video signal flow in a system 100 that uses rear view camera images in a surround view. The system 100 may be implemented in a vehicle, such as an automobile, to provide display of rear view and surround view images. The system 100 includes a video processing subsystem 102, cameras 110, 112, 114, and 116, and a display device 108. The video processing subsystem 102 is coupled to the cameras 110, 112, 114, and 116, and to the display device 108. The camera 110 may be a rear view camera positioned to capture images from the rear of the vehicle. The camera 112 may be a side view camera positioned to capture images from a first side (e.g., a driver side) of the vehicle. The camera 114 may be a side view camera positioned to capture images from a second side (e.g., a passenger side) of the vehicle. The camera 116 May be a front view camera positioned to capture images from a front of the vehicle. The cameras 110, 112, 114, and 116 may include lenses, image sensors, video transmission circuitry, etc. The display device 108 displays images received from the video processing subsystem 102. The display device 108 may include a display panel, (such as a liquid crystal display panel, an organic light emitting diode display panel, etc.), display driver circuitry, and video receiver circuitry. The video processing subsystem 102 may also or alternatively transmit images to a remote device via Ethernet or other networking apparatus for display and/or analysis.

The video processing subsystem 102 includes processor cores 104 and 106. The processor core 104 may be configured to execute a general-purpose operating system that provide many features, but initializes (e.g., boots up) relatively slowly. The processor core 106 may be configured to execute a “lighter weight” operating system (e.g., a real-time operating system) that initializes relatively quickly. For example, the processor core 106 may boot up and begin application execution in less than a second, while the processor core 104 may take several seconds to initialize.

When the processor core 106 has been initialized, and while the processor core 104 is initializing, the processor core 106 configures the video processing subsystem 102 to receive video from the cameras 110, 112, 114, and 116, generate a rear view image, and provide the rear view image to the display device 108. In some examples, the processor core 106 may be initialized and a rear view image provided to the display device 108 within about 2 seconds after initialization of the processor core 106 is started (e.g., about 2 seconds after power-up or reset). In configuring the video processing subsystem 102, the processor core 106 may activate a rear view camera capture module 118 to receive video from the camera 110, and sensor capture modules 124 to receive video from the cameras 112, 114 and 116. The processor core 106 may also activate a split/duplicate module 120. The split/duplicate module 120 receives the rear view camera video provided by the camera capture module 118, and duplicates the received video stream to generate a rear view video stream 122 that is transmitted to the display device 108 for display, and another video stream that is provided to the surround view module 126.

When the processor core 104 has been initialized, which may be a substantial time (e.g., seconds) after the processor core 106 has completed initialization and configured the video processing subsystem 102 for rear view display, the processor core 104 configures the video processing subsystem 102 to process the video streams provided by the split/duplicate module 120 and the sensor capture modules 124, and generate a surround view image. Configuration of the video processing subsystem 102 by the processor core 104 includes activation of the surround view module 126. The surround view module 126 receives the video streams from the split/duplicate module 120 and the sensor capture modules 124, and processes the video streams (e.g., stitches together the rear, front, and side images) to generate a surround or “bird's eye” view. The surround view module 126 may operate in parallel with the generation of the rear view video stream 122.

In some implementations of rear view and surround view image processing, rear view image processing is initialized prior to surround view processing as described above, but the rear view image processing is disabled prior to activation of the surround view processing, which increases delay and complexity in the transition from rear view to surround view. In the system 100, by duplicating the rear view video stream, the rear view video display is providing with little delay (e.g., less the 2 seconds), and the complexity of rear view to surround view handoff is avoided by providing rear view and surround view in parallel. Other implementations of rear view and surround view use a first rear view camera for rear view, and a second rear view camera for surround view to allow quick switching between views. The system 100 allows quick switching between rear view and surround view without the use of two rear view cameras.

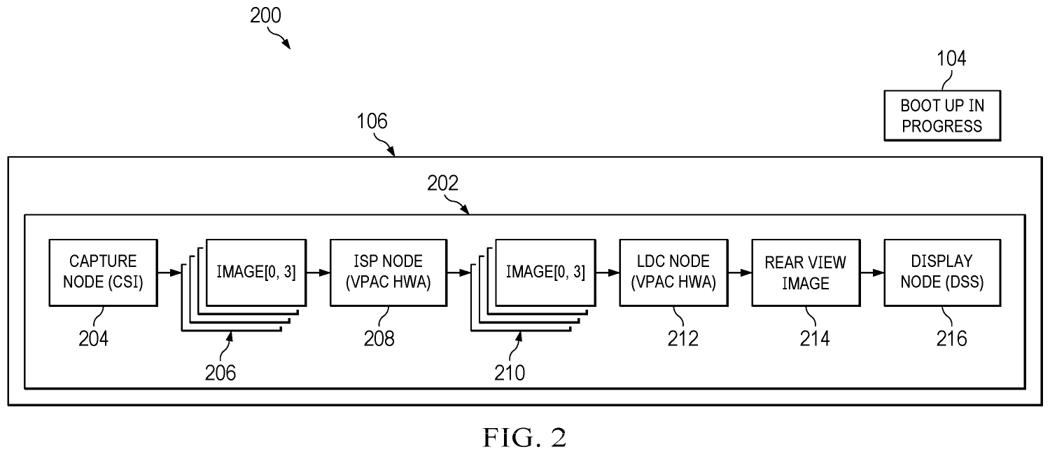

FIG. 2 is a block diagram of example processing 200 of rear view camera images prior to initialization of surround view processing. In FIG. 2, the processor core 104 is initializing (boot up in progress), and initialization of the processor core 106 is complete. The processor core 106 configures a rear view image processing path 202, and configures the cameras 110, 112, 114, and 116 to stream video to the rear view image processing path 202. The rear view image processing path 202 includes a capture node 204, an image signal processing (ISP) node 208, a lens distortion correction (LDC) node 212, and a display node 216. The capture node 204 receives the video streams from the cameras 110, 112, 114, and 116, and outputs the images 206 (e.g., a rear view image, a front view image, first side view image, and a second side view image). The image signal processing node 208 receives the images 206 and processes the received images (e.g., converts RAW image sensor data into processed YUV or RGB images) to generate processed images 210. From the processed images 210, the rear view image is provided to the lens distortion correction node 212. The lens distortion correction node 212 processes the rear view image to correct for distortion introduced by the lens of the camera 110 to produce the rear view image 214. The display node 216 may transmit the rear view image 214 to the display device 108 for display.

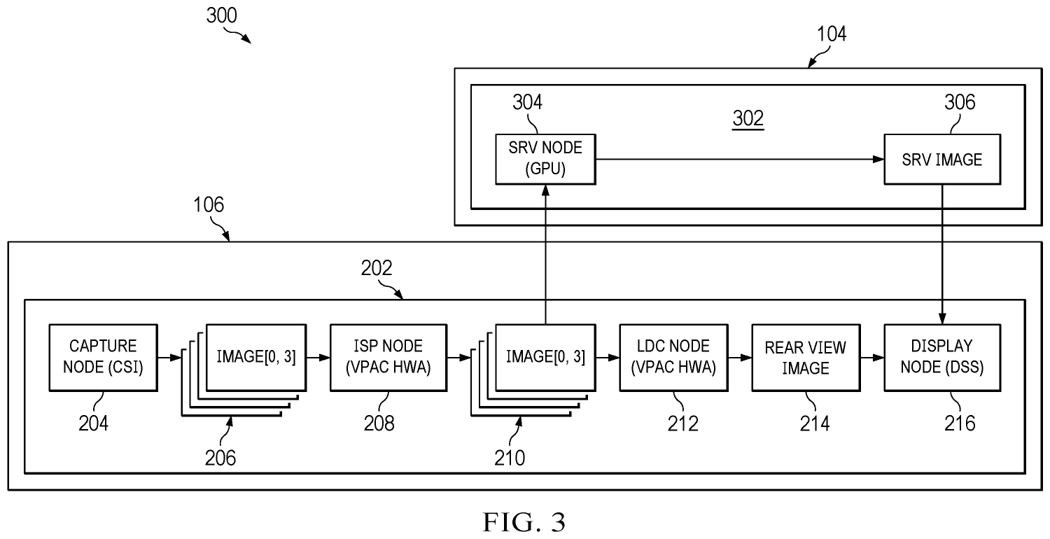

FIG. 3 is a block diagram of example processing 300 of video from multiple cameras for generating a surround view using the rear view image generated in the rear view image processing path 202. In the processing 300, the rear view image processing path 202 operates as described with regard to FIG. 2. The initialization of the processor core 104 is complete, and the processor core 104 configures a surround view image processing path 302. The surround view image processing path 302 includes a surround view node 304. The surround view node 304 receives the processed images 210 from the rear view image processing path 202, and stitches the images together to create a panoramic surround view (SRV) image 306. The surround view image 306 shows a 360° view of the vehicle's surroundings. The stitching process may align the images correct for distortion, and blend the images together.

The display node 216 receives the surround view image 306 from the surround view image processing path 302. The display node 216 may display the rear view image 214 and/or the surround view image 306 as needed based on vehicle operation. For example, the display node 216 may transmit the rear view image 214 to the display device 108 for display if the vehicle is in reverse, and transmit the surround view image 306 to the display device 108 for display in other vehicle operating scenarios.

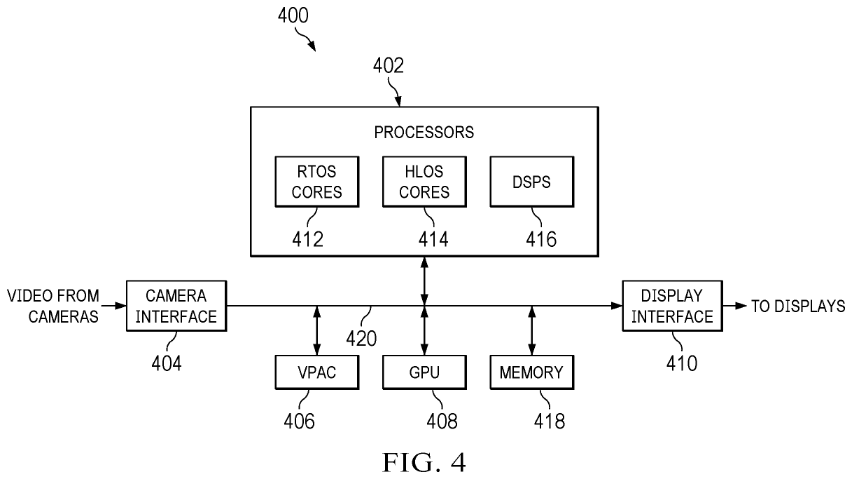

FIG. 4 is a block diagram of an example processing circuit 400 suitable for implementing the processing 200 and the processing 300. Examples of the processing circuit 400 may be provided in a system-on-chip suitable for automotive video processing. The processing circuit 400 includes processors 402, a camera interface 404, a vision pre-processing accelerator (VPAC) 406, a graphics processor (GPU) 408, a display interface 410, and a memory 418. The processors 402, the camera interface 404, the VPAC 406, the GPU 408, the display interface 410, and the memory 418 are coupled via interconnect memory 420. The processors 402 may include real-time operating system (RTOS) cores 412, high-level operating system (HLOS) cores 414, digital signal processor (DSP) cores 416, and/or other processor cores. The RTOS cores 412 include processor cores selected to execute a real-time operating system. The HLOS cores 414 include processor cores selected to execute a high-level (e.g., general-purpose) operating system, such as LINUX. An RTOS cores 412 may be used to implement the processor core 106. One or more of the HLOS cores 414 may be used to implement the processor core 104. The RTOS cores 412 and the HLOS cores 414 may be implemented using the same or different processor architectures.

The camera interface 404 includes circuitry to interface cameras to the processing circuit 400. For example, the camera interface 404 may include multiple mobile industry processor interface camera serial interfaces (MIPI-CSI) for interfacing the processing circuit 400 to the cameras 110, 112, 114, and 116. The camera interface 404 may be used to implement the capture node 204 for receiving video streams transmitted by the cameras 110, 112, 114, and 116.

The VPAC 406 is a hardware accelerator that can be configured to accelerate image processing tasks such as color processing and enhancement, noise filtering, wide dynamic range processing, lens distortion correction, pixel remap for dewarping, on-the-fly scale generation, on-the-fly pyramid generation, etc. The VPAC 406 can be used to implement the image signal processing node 208 and/or the lens distortion correction node 212.

The GPU 408 can be programmed to accelerate 3-dimensional (3D) and 2-dimensional (2D) graphics and compute applications. The GPU 408 can be used to implement the surround view node 304.

The display interface 410 is a display subsystem that supports one or more high resolution display outputs. It may include a Display Controller (DISPC) and a Frame Buffer Decompression Core (FBDC). The DISPC may support multi-layer blending and transparency for each of its display outputs. The DISPC may also support a write-back pipeline with scaling to enable memory-to-memory composition and/or to capture a display output for Ethernet video encoding. The display interface 410 may include a MIPI Digital Serial Interface (DSI) Controller and/or a Video Electronics Standards Association Display Port1 (VESA DP1) Compliant Transmitter Host Controller for transmitting video to the display device 108. The display interface 410 can be used to implement the display node 216.

The various video manipulation circuits of the processing circuit 400 may individually or collectively be referred to as video processing circuits. For example, the camera interface 404, the VPAC 406, the GPU 408, and/or the display interface 410 may be referred to as a video processing circuit.

The memory 418 may include semiconductor memory including volatile or non-volatile memory, static or dynamic random access memory, or other types of non-transitory computer-readable media used to store programming and data used by or provided by the processors 402, the camera interface 404, the VPAC 406, the GPU 408, and/or the display interface 410. The memory 418 may provide storage for the images 206, the processed images 210, the rear view image 214, and the surround view image 306, and storage for instructions executed by the processors 402, the VPAC 406, the GPU 408, the camera interface 404, and/or the display interface 410.

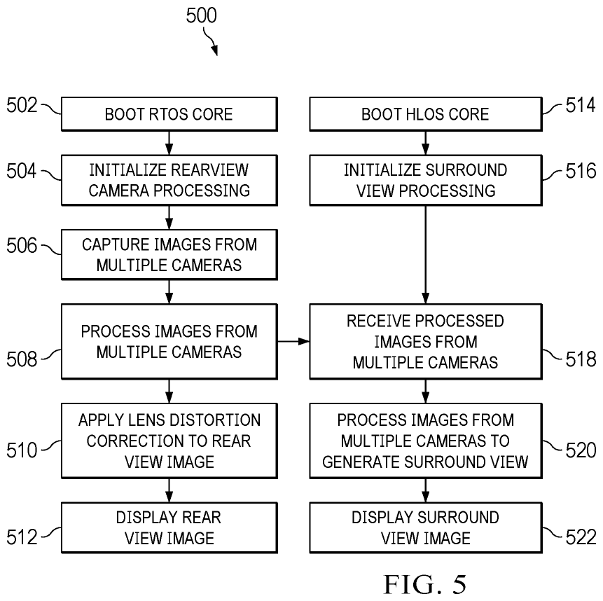

FIG. 5 is a flow diagram for an example method 500 of providing a surround view image based on images provided by a rear view processing stream. Though depicted sequentially as a matter of convenience, at least some of the actions shown can be performed in a different order and/or performed in parallel. Additionally, some implementations may perform only some of the actions shown. Operations of the method 500 may be performed by the processing circuit 400 as illustrated in the processing 200 and the processing 300.

In block 502, one of the RTOS cores 412 is initialized (boots up) to operate as the processor core 106. The RTOS cores 412 may boot relatively quickly (e.g., less than a second) after power-up or reset.

In block 504, the booting of the processor core 106 is complete, and the processor core 106 initializes the rear view image processing path 202. For example, an RTOS core 412 may configure the camera interface 404 to operate as the capture node 204, configure the VPAC 406 to operate as the image signal processing node 208 and the lens distortion correction node 212, and configure the display interface 410 to operate as the display node 216.

In block 506, the camera interface 404 captures images transmitted by the cameras 110, 112, 114, and 116. The camera interface 404 may store the received video in the memory 418.

In block 508, the images captured in block 506 are processed. For example, the VPAC 406 may process the captured images to convert RAW image data received from the cameras 110, 112, 114, and 116 to YUV or RGB images.

In block 510, lens distortion correction is applied to the rear view image generated in block 508. For example, the VPAC 406 may process the rear view image to provide lens distortion correction.

In block 512, the rear view image is displayed. For example, the display interface 410 may transmit the rear view image generated in block 510 to the display device 108 for display. The time needed to execute the operations of the blocks 502-512 may be two seconds or less.

In block 514, one of the HLOS cores 414 is initialized (boots up) to operate as the processor core 104. The HLOS cores 414 may boot relatively slowly (e.g., more than two seconds) after power-up or reset. Initialization of the HLOS cores 414 may start at about the same time as initialization of the RTOS cores 412.

In block 516, initialization of the processor core 104 is complete, and the processor core 104 initializes the surround view image processing path 302. For example, a HLOS core 414 may configure the GPU 408 to operate as the surround view node 304. The surround view image processing path 302 operates concurrently with the rear view image processing path 202. In some examples of the method 500, the operations of blocks 502-512 may be complete prior to the operations of the block 516.

In block 518, the surround view image processing path 302 receives the processed images 210 from the rear view image processing path 202.

In block 520, surround view processing is applied to the images received from the rear view image processing path 202. For example, the surround view image processing path 302 (the surround view node 304) processes the processed images 210 to generate the surround view image 306.

In block 522, the surround view image 306 is displayed. For example, the display node 216 transfers the surround view image 306 to the display device 108 for display.

The same reference numbers or other reference designators are used in the drawings to designate the same or similar (either by function and/or structure) features.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more active or passive elements or subsystems may instead include only a subset of the elements and may be adapted to be coupled to at least some of the elements to form the described structure either at a time of manufacture or after a time of manufacture, for example, by an end-user and/or a third-party.

Circuits described herein are reconfigurable to include additional or different components to provide functionality at least partially similar to functionality available prior to the component replacement.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Modifications are possible in the described embodiments, and other embodiments are possible, within the scope of the claims.

What is claimed is:

1. A circuit comprising:
a first processor core, a second processor core, and a video processing circuit, in which:
the first processor core is configured to program the video processing circuit to: provide a rear view image processing path; and
transfer a rear view image from the rear view image processing path to a surround view image processing path;
the second processor core is configured to program the video processing circuit to:
provide the surround view image processing path;
receive the rear view image from the rear view image processing path; and
provide a surround view image based on the rear view image.

2. The circuit of claim 1, wherein the first processor core is configured to program the video processing circuit to provide the rear view image processing path before the second processor core programs the video processing circuit to provide the surround view image processing path.

3. The circuit of claim 1, wherein the rear view image processing path is configured to operate concurrently with the surround view image processing path.

4. The circuit of claim 1, further comprising a display interface, in which:
the rear view image processing path is configured to transfer the rear view image to the display interface; and
the surround view image processing path is configured to transfer the surround view image to the display interface.

5. The circuit of claim 1, further comprising a camera interface, in which:
the rear view image processing path is configured to:
receive a rear view video signal from the camera interface; and
generate the rear view image based on the rear view video signal.

6. The circuit of claim 5, wherein the rear view image processing path is configured to:
receive a first side view video signal, a second side view video signal, and a front view video signal from the camera interface;
generate a first side view image, a second side view image, and a front view image based on the first side view video signal, the second side view video signal, and the front view video signal; and
transfer the first side view image, the second side view image, and the front view image to the surround view image processing path.

7. The circuit of claim 6, wherein the surround view image processing path is configured to generate the surround view image based on the rear view image, the first side view image, the second side view image, and the front view image received from the rear view image processing path.

8. A method comprising:
programming a video processing circuit to provide a rear view image processing path;
generating a rear view image in the rear view image processing path;
programming the video processing circuit to provide a surround view image processing path;
transferring the rear view image from the rear view image processing path to the surround view image processing path; and
generating a surround view image, based on the rear view image, in the surround view image processing path.

9. The method of claim 8, further comprising:
programming the rear view image processing path by a first processor core; and
programming the surround view image processing path by a second processor core.

10. The method of claim 8, further comprising generating the rear view image in the rear view image processing path before the surround view image processing path is operational.

11. The method of claim 8, further comprising operating the rear view image processing path concurrently with the surround view image processing path.

12. The method of claim 8, further comprising:
providing the rear view image to a display interface;
providing the surround view image to the display interface;
displaying the rear view image; and
displaying the surround view image.

13. The method of claim 8, further comprising:
receiving, in the rear view image processing path, a rear view video signal, a first side view video signal, a second side view video signal, and a front view video signal; and
processing, by the rear view image processing path, the rear view video signal to produce the rear view image.

14. The method of claim 13, further comprising:
processing, in the rear view image processing path, the first side view video signal, the second side view video signal, and the front view video signal to produce a first side view image, a second side view image, and a front view image; and
transferring the first side view image, the second side view image, and the front view image to the surround view image processing path.

15. The method of claim 14, further comprising processing, in the surround view image processing path, the rear view image, the first side view image, the second side view image, and the front view image received from the rear view image processing path to produce the surround view image.

16. A system comprising:
a camera interface, a video processing circuit, a first processor core, a second processor core, and a display interface, in which:
the camera interface is configured to receive a rear view video signal, a first side view video signal, a second side view video signal, and a front view video signal;
the video processing circuit is coupled to the camera interface;
the first processor core is coupled to the video processing circuit, the first processor core is configured to program the video processing circuit to: provide a rear view image processing path;
provide a rear view image based on the rear view video signal; and
transfer the rear view image from the rear view image processing path to a surround view image processing path;
the second processor core is coupled to the video processing circuit, the second processor core is configured to program the video processing circuit to:
provide the surround view image processing path;
receive the rear view image from the rear view image processing path; and
provide a surround view image based on the rear view image; and
the display interface is coupled to the video processing circuit, the display interface is configured to provide the rear view image and the surround view image to a video display device.

17. The system of claim 16, wherein the first processor core is configured to program the video processing circuit to provide the rear view image processing path before the second processor core programs the video processing circuit to provide the surround view image processing path.

18. The system of claim 16, wherein the rear view image processing path is configured to operate concurrently with the surround view image processing path.

19. The system of claim 16, wherein:
the rear view image processing path is configured to:
receive the first side view video signal, the second side view video signal, and the front view video signal from the camera interface;
generate a first side view image, a second side view image, and a front view image based on the first side view video signal, the second side view video signal, and the front view video signal; and
transfer the first side view image, the second side view image, and the front view image to the surround view image processing path; and
the surround view image processing path is configured to generate the surround view image based on the rear view image, the first side view image, the second side view image, and the front view image received from the rear view image processing path.

20. The system of claim 16, further comprising:
a rear view camera, a first side view camera, a second side view camera, and a front view camera coupled to the camera interface; and
a video display device coupled to the display interface.
